(19) United States
(12) Patent Application Publication
(10) Pub. No.: US 2026/0035311 A1
(43) Pub. Date: Feb. 5, 2026

(54) CERAMIC MATRIX COMPOSITE PREFORM INFILTRATION

(71) Applicant: RTX Corporation, Farmington, CT (US)

(72) Inventors: Daniel MASTROBATTISTO, Aliso Viejo, CT (US); Vahid HEJAZI, Carlsbad, CA (US); Weiming LU, Copley, OH (US)

(73) Assignee: RTX Corporation, Farmington, CT (US)

(21) Appl. No.: 18/792,660

(22) Filed: Aug. 2, 2024

(51) Int. Cl. C04B 41/50; C04B 35/58; C04B 35/80; C04B 41/00; C04B 41/51

(52) U.S. Cl. CPC C04B 41/5057; C04B 35/58085; C04B 35/80; C04B 41/0063; C04B 41/5133; C04B 2235/5244; C04B 2235/5248; C04B 2235/5445

(57) ABSTRACT

A method is provided for densifying a ceramic matrix composite (CMC) preform in which a porous CMC preform is subjected to slurry infiltration wherein metal carbide particulate material is introduced into the spaces between fiber tows of the CMC preform to form an infiltrated CMC preform. Thereafter, molten metal or molten metal alloy is introduced into the infiltrated CMC preform by melt infiltration to react the metal or molten metal alloy with the metal carbide particulate material and create a ceramic matrix within the CMC preform forming a ceramic matrix composite. The metal carbide particulate material is selected from zirconium carbide particles, hafnium carbide particles, tantalum carbide particles, niobium carbide particles, titanium carbide particles, tungsten carbide particles, cobalt carbide particles, vanadium carbide particles, chromium carbide particles, ytterbium carbide particles, yttrium carbide particles, tantalum hafnium carbide particles, and mixtures thereof.

### FIELD OF THE INVENTION

The subject matter disclosed herein relates to ceramic matrix composites (CMC) and methods of making CMCs, and, in particular, to prepping CMC preforms prior to melt-infiltration.

### BACKGROUND OF THE INVENTION

Due to their high heat resistance, mechanical strength, and stability, ceramic matrix materials (CMCs) are often used in applications exhibiting high heat environments (e.g., >1200° C.), for example, high-temperature components of gas turbine engines such as blades, combustion chamber liners, and blade outer air seals (BOAS). CMC materials can involve fiber tows (e.g., SiC or C fiber tows) which are embedded in a ceramic matrix.

To produce CMCs, a preform, made from woven fiber tows (exhibiting 2-dimensional and/or 3-dimensional weaves), can be initially prepared. The preform can then be infiltrated with a particulate ceramic matrix precursor material which acts as a carbon source (e.g., graphite, diamond), for example, by slurry infiltration. Thereafter, the infiltrated preform can be subjected to melt infiltration in which infused molten Si or a molten Si alloy reacts with the carbon source to form SiC

The reaction between Si and the carbon source particles can result in a SiC diffusion barrier forming around the carbon source particles which can hinder complete reaction of the carbon leading to the presence of residual carbon in the CMC. Such residual carbon particles can be problematic as they can convert to CO/CO₂ upon exposure to high temperature oxygen, which in turn can cause cracks to form in the CMC reducing the operation lifetime of the CMC component.

There exists a continuing to need for materials, methods, and techniques for producing CMCs that can enhance the properties of such CMCs and/or facilitate the manufacture thereof.

### SUMMARY OF THE INVENTION

In general, the present disclosure relates to methods for preparing CMCs by melt infiltration. In particular, the present disclosure relates to preparing CMCs by introducing carbon source material into CMC preforms by slurry infiltration.

The present disclosure is directed, in a first aspect, to a method of densifying a ceramic matrix composite (CMC) preform comprising:
providing a porous CMC preform;
introducing metal carbide particulate material into the CMC preform by slurry infiltration to form an infiltrated CMC preform; and
introducing molten metal, metalloid, metal alloy, or metalloid alloy into the infiltrated CMC preform by melt infiltration to react at least one metal, at least one metalloid, at least one metal alloy, or at least one metalloid alloy with the metal carbide particulate material and form a ceramic matrix within the CMC preform and thereby forming a ceramic matrix composite,
wherein the metal carbide particulate material is selected from zirconium carbide particles, hafnium carbide particles, tantalum carbide particles, niobium carbide particles, titanium carbide particles, tungsten carbide particles, cobalt carbide particles, vanadium carbide particles, chromium carbide particles, ytterbium carbide particles, yttrium carbide particles, tantalum hafnium carbide particles, and mixtures thereof, and
wherein the ceramic matrix composite contains <80 wt. % silicides and <30 wt. % MAX phase carbides.

In yet another embodiment, the present disclosure is directed to a ceramic matrix composite (CMC) prepared by a method comprising:
providing a porous CMC preform;
introducing metal carbide particulate material into the CMC preform by slurry infiltration to form an infiltrated CMC preform; and
introducing molten metal, metalloid, metal alloy, or metalloid alloy into the infiltrated CMC preform by melt infiltration to react at least one metal, at least one metalloid, at least one metal alloy, or at least one metalloid alloy with the metal carbide particulate material and form a ceramic matrix within the CMC preform and thereby forming a ceramic matrix composite,
wherein the metal carbide particulate material is selected from zirconium carbide particles, hafnium carbide particles, tantalum carbide particles, niobium carbide particles, titanium carbide particles, tungsten carbide particles, cobalt carbide particles, vanadium carbide particles, chromium carbide particles, ytterbium carbide particles, yttrium carbide particles, tantalum hafnium carbide particles, and mixtures thereof, and
wherein the ceramic matrix composite contains <80 wt. % silicides and <30 wt. % MAX phase carbides.

In yet another embodiment, the present disclosure is directed to a densified ceramic matrix composite (CMC) prepared by the method comprising:
providing a porous CMC preform;
introducing metal carbide particulate material in the form of a slurry comprising a dispersion medium and the metal carbide particulate material into the CMC preform by slurry infiltration to form an infiltrated CMC preform;
freeze-drying the infiltrated preform by freezing the infiltrated preform to a temperature below the freezing point of the dispersion medium and removing frozen dispersion medium by sublimation, and
introducing molten metal, metalloid, metal alloy, or metalloid alloy into the infiltrated CMC preform by melt infiltration to react the metal or molten metal alloy with the metal carbide particulate material and form a ceramic matrix within the CMC preform and form a ceramic matrix composite,
wherein the metal carbide particulate material is selected from zirconium carbide particles, hafnium carbide particles, tantalum carbide particles, niobium carbide particles, titanium carbide particles, tungsten carbide particles, cobalt carbide particles, vanadium carbide particles, chromium carbide particles, ytterbium carbide particles, yttrium carbide particles, tantalum hafnium carbide particles, and mixtures thereof, and
wherein the ceramic matrix composite contains <80 wt. % silicides and <30 wt. % MAX phase carbides.

In yet another embodiment, the present disclosure is directed to a ceramic matrix composite (CMC) which contains <80 wt. % silicides and <30 wt. % MAX phase carbides.

In further embodiments of the present disclosure, including further embodiments of the above exemplary embodiments, the CMC preform contains SiC or C fiber tows.

In further embodiments of the present disclosure, including further embodiments of the above exemplary embodiments, the metal, metalloid, metal alloy, or metalloid alloy is selected from Si, Hf—Si, Zr—Si, Ti—Si, Ta—Si, Ir—Si, Mo—Si, W—Si, B—Si, Nb—Si, Yb—Si, V—Si, Sc—Si, and Y—Si, and mixtures thereof.

In further embodiments of the present disclosure, including further embodiments of the above exemplary embodiments, the metal, metalloid, metal alloy, or metalloid alloy is selected from Si—Zr alloys and Si—Hf alloys.

In further embodiments of the present disclosure, including further embodiments of the above exemplary embodiments, the metal carbide particulate material is selected from titanium carbide, zirconium carbide, hafnium carbide, and mixtures thereof.

In further embodiments of the present disclosure, including further embodiments of the above exemplary embodiments, the slurry comprises the metal carbide particulate material and a dispersion medium, wherein the dispersion medium is selected from water and organic solvents.

In further embodiments of the present disclosure, including further embodiments of the above exemplary embodiments, the slurry further contains one or more slurry additives selected from organic binders, pH adjusters, dispersants, wetting agents, and/or surfactants.

In further embodiments of the present disclosure, including further embodiments of the above exemplary embodiments, the slurry further contains a carbon source material selected from carbon black, graphite, diamond, pitch, resin, and mixtures thereof.

In further embodiments of the present disclosure, including further embodiments of the above exemplary embodiments, the slurry contains 1 to 70 vol. % metal carbide particles.

In further embodiments of the present disclosure, including further embodiments of the above exemplary embodiments, the slurry contains 1 to 20 vol. % metal carbide particles.

In further embodiments of the present disclosure, including further embodiments of the above exemplary embodiments, the metal carbide particulate material is in the form of particles having a particle size range of 0.1 to 50 km.

In further embodiments of the present disclosure, including further embodiments of the above exemplary embodiments, the metal carbide particulate material is in the form of particles having a particle size range of 0.25 to 1.0 km.

In further embodiments of the present disclosure, including further embodiments of the above exemplary embodiments, the method further includes freeze-drying the slurry infiltrated CMC preform prior to the melt infiltration.

In further embodiments of the present disclosure, including further embodiments of the above exemplary embodiments, the fiber tows or fibers thereof are coated with a fiber protection layer.

### BRIEF DESCRIPTION OF FIGURES

The features of the disclosure believed to be novel and the elements characteristic of the invention are set forth with particularity in the appended claims. The figures are for illustration purposes only and are not drawn to scale. The disclosure itself, however, both as to organization and method of operation, can best be understood by reference to the description of the preferred embodiment(s) which follows, taken in conjunction with the accompanying drawings in which:

FIG. 1 is a flow chart showing steps of a process for preparation of CMCs by slurry infiltration and melt infiltration in which a carbon material is used during slurry infiltration.

FIG. 2A is a schematic drawing of a cross sectional region of a slurry infiltrated preform subjected to melt infiltration with a molten material.

FIG. 2B is a schematic drawing of a cross sectional region of a slurry infiltrated preform undergoing melt infiltration with a molten material and the development of a diffusion barrier resulting from the reaction between the carbon material and the molten material.

FIG. 3 is a flow chart showing steps of a process for preparation of CMCs by slurry infiltration and melt infiltration in which a metal carbide material is used during slurry infiltration.

### DETAILED DESCRIPTION OF THE INVENTION

The embodiments of the present disclosure can comprise, consist of, and consist essentially of the features and/or steps described herein, as well as any of the additional or optional ingredients, components, steps, or limitations described herein or would otherwise be appreciated by one of skill in the art. It is to be understood that all concentrations disclosed herein are by weight percent (wt. %.) based on a total weight of the composition unless otherwise indicated.

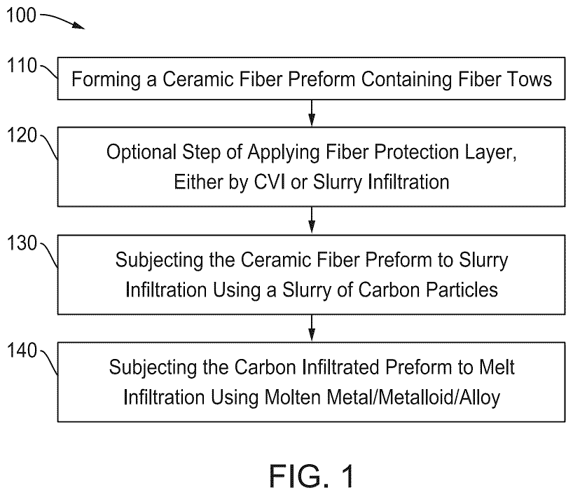

The present disclosure is directed to a method of forming a CMC by melt infiltration. FIG. 1 is a flowchart illustrating a melt infiltration process 100 in which initially a ceramic fiber porous preform containing fiber tows is prepared 110. The fiber tows of the preform are formed as bundles of continuous or short fibers or filaments or whiskers made from, for example, SiC, C, Si₃N₄, Al₂O₃, or SiO₂. These fibers or fiber tows can, optionally, be provided with an interface coating (IFC), for example, a carbon and/or boron nitride coating, which allows the fibers or fiber tows to slide relative to the matrix. Optionally, as discussed further below, the fiber tows or the fibers thereof can be coated with a fiber protection layer by, for example, CVI or slurry infiltration 120. Thereafter, the preform is subject to slurry infiltration 130 in which a slurry of carbon particles, such as graphite, carbon black, or diamond particles, is introduced into the preform. The slurry infiltration results in the carbon particles being deposited within the inner spaces or pores between the fiber tows of the preform. The carbon infiltrated preform is then subjected to melt infiltration 140 wherein a molten material (e.g., Si or Si alloy) is introduced into the preform. The molten material reacts with the carbon material to form a matrix (e.g., a SiC matrix) around the fiber tows of the preform thereby forming a ceramic matrix composite (CMC) material.

Prior to slurry infiltration, the fiber tows, which may be provided with an IFC as mentioned above, can be coated with a fiber protection layer. The fiber protection layers contain fiber protection materials to prevent rapid reaction of the fibers and/or the IFC with, for example, silicon or silicon alloys, during melt infiltration. The fiber protection layer can be applied using CVI (chemical vapor infiltration) or through slurries. Suitable fiber protective materials include, but are not limited to, various carbides, including but not limited to, boron carbides, zirconium carbides, hafnium carbides, tantalum carbides, niobium carbides, titanium carbides, molybdenum carbides, tungsten carbides, vanadium carbides, chromium carbides, ytterbium carbides, yttrium carbides, and combinations of any of the foregoing, and the like; nitrides including, but not limited to, silicon nitrides, titanium nitrides, boron nitrides, zirconium nitrides, hafnium nitrides, niobium nitrides, tantalum nitrides, vanadium nitrides, ytterbium nitrides, yttrium nitrides, and combinations of any of the foregoing, and the like; or borides, including but not limited to, silicon borides, titanium borides, zirconium borides, hafnium borides, niobium borides, tantalum borides, vanadium borides, ytterbium borides, yttrium borides, combinations of any of the foregoing, and the like.

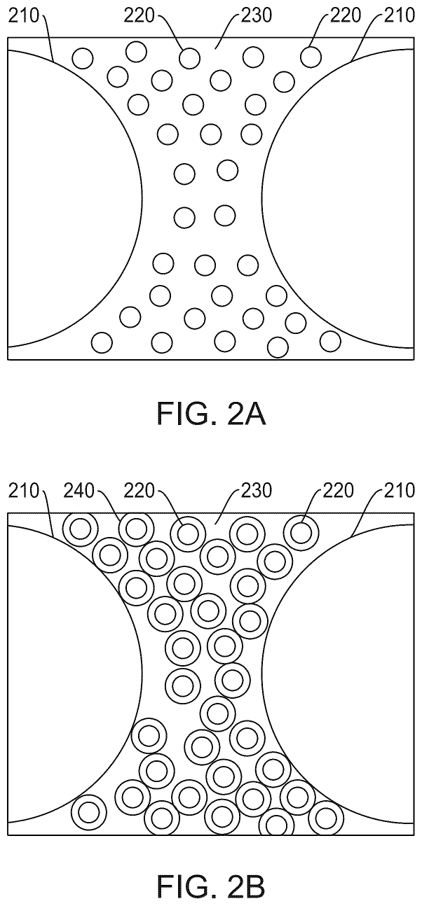

FIGS. 2A and 2B illustrate the reaction procedure between the carbon particles and the molten Si/Si alloy. FIG. 2A shows two fibers 210 of ceramic preform between which carbon particles 220 are introduced by the slurry infiltration. During the melt infiltration these carbon particles come into contact with a molten Si/Si alloy 230. As mentioned above, during the melt infiltration step, the reaction between the carbon and the molten Si/Si alloy can result in formation of a SiC diffusion barrier 240 as shown in FIG. 2B. The SiC diffusion barrier 240 around the carbon particles inhibits the reaction between the carbon and the molten Si/Si alloy thus resulting in residual carbon being present within the resultant CMC material. When exposed to high temperature oxygen, the residual carbon is subject to reaction with the oxygen leading to formation of CO/CO₂. The presence of CO/CO₂ can lead to crack formations in the CMC component thereby reducing the operational lifespan of the CMC component.

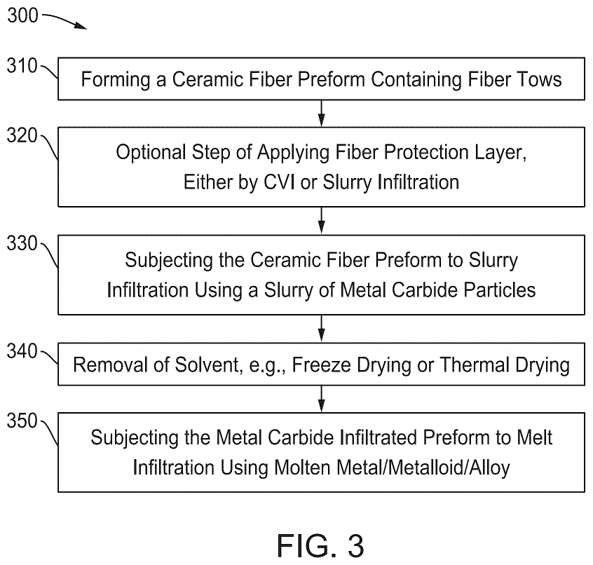

FIG. 3 is a flowchart illustrating a melt infiltration process 300 in accordance with the present disclosure in which particles of metal carbide are used as a carbon source for reaction with the melt. As shown in FIG. 3, a porous ceramic fiber preform containing fiber tows is initially prepared 310. The fiber tows of the preform are formed as bundles of continuous or short fibers or filaments or whiskers made from, for example, SiC, C, Si₃N₄, Al₂O₃, or SiO₂. The fiber or fiber tows may have an IFC as mentioned above. Optionally, as discussed above, the fiber tows or the fibers thereof can be coated with a fiber protection layer by, for example, CVI or slurry infiltration 320. Thereafter, the preform is subject to infiltration 330 (e.g., slurry infiltration) in which metal carbide particles are introduced into the preform. The slurry infiltration results in the metal carbide particles being deposited within the inner spaces or pores between the fiber tows of the preform. Following slurry infiltration, the infiltrated preform can be subjected to a drying step 340 for removal of solvent or dispersion medium. The infiltrated preform is then subjected to melt infiltration 350 wherein molten material (e.g., Si or Si alloy) is introduced into the preform. The metal carbide particles react with the molten metal to form a matrix (e.g., a SiC matrix) and silicide around the fiber tows of the preform thereby forming a ceramic matrix composite material. Melt infiltration can also result in the formation of MAX phase carbides (Mₙ₊₁AXₙ wherein M is a transition metal selected from Ti, V, Cr, Sc, Zr, Nb, Mo, Hf, and Ta, A is a group-A element selected from Al, Si, P, S, Ga, Ge, As, Cd, In, Sn, Tl and Pb, X is carbon or nitrogen, and n is an integer from 1 to 3) such as described is U.S. Pat. No. 9,856,176.

To limit coefficient of thermal expansion (CTE) mismatch between the matrix and fiber reinforcement, it is desirable to minimize the silicide content and MAX phase carbide compound in the final matrix composition. For example, the final matrix composition can contain <80 wt. % silicides (for example, <70 wt. %, <60 wt. %, <50 wt. %, <40 wt. %, or <30 wt. % silicides) and <30% wt. % MAX phase carbides or <25 wt. % MAX phase carbides or <20 wt. % MAX phase carbides or <15 wt. % MAX phase carbides or <10 wt. % MAX phase carbides or <5 wt. % MAX phase carbides. The final matrix composition can contain, for example, 50-70% atomic Si (such as 50-60% or 55-70% or 55-65%), 20-50% atomic C (such as 20-40% or 20-30% or 25-45%), with the remainder being metals (derived from the metal carbide particles or an alloy melt). The amount of silicides and MAX phase carbides can be controlled by limiting the amount of metal introduced, either by way of the metal carbide particles during slurry infiltration or by way of melt infiltration with an alloy, into the preform and/or by adjusting process conditions during melt infiltration such as melt infiltration temperature and duration of melt infiltration.

If during melt infiltration a SiC diffusion barrier forms around the metal carbide particles inhibiting the reaction between carbon and Si, the residual metal carbide material may be present in the CMC. However, compared to residual carbon material, residual metal carbide material is less susceptible to being converted to CO/CO₂ by high temperature oxygen.

Suitable metal carbides for use in the disclosed method may include, but are not limited to, zirconium carbides, hafnium carbides, tantalum carbides, niobium carbides titanium carbides, tungsten carbides, cobalt carbides, vanadium carbides, chromium carbides, ytterbium carbides, yttrium carbides, metal carbide combinations such as tantalum hafnium carbides, and mixtures thereof.

The metal carbide particles can be introduced into the preform by slurry infiltration. The slurry can be prepared by combining metal carbide particles with a carrier material or dispersion medium which can be, for example, water or an organic solvent. The pH of the slurry can be, for example, 5 to 11. The slurry can further contain other components as additives such as organic binders, pH adjusters, dispersants, wetting agents, and/or surfactants (such as additives made by Triton and BYK, e.g., Triton X-100®, BYK156®, etc.). The slurry may also contain other particles including particles such as SiC particles to aid in formation of the matrix or particles that can act as an additional carbon source, including but not limited to carbon black, graphite, diamond, pitch, and/or resin (e.g., phenolic resin). Also, pyrolytic carbon can be added by CVI to the preform as an additional carbon source.

The slurry can contain metal carbide particles in an amount of, for example, about 1 vol. % to about 70 vol % such as about 20 vol % to about 65 vol %, about 30 vol % to about 50 vol %, or about 25 vol % to 40 vol %. When used in combination with other carbon source particles, the amount of metal carbide particles in the slurry can be lower, for example, about 1-20 vol % such as about 1-10 vol % or 1-5 vol % or 5-15 vol %. The metal carbide particles can be in various including but not limited to flakes, particulates, and/or fibers. With regards to size, the metal carbide particles generally are of a size that will permit them enter into the interstitial spaces between fiber tows in the preform. Suitable particles size ranges include, but are not limited to, for example, about 0.1 μm to about 50 μm, about 0.25 μm to 12 μm, about 0.25 to 1.0 μm, or about 5 to 10 μm. Blends of particle size ranges can also be used such as a blend of 0.25 to 1.0 μm particles with 5 to 10 μm particles.

Infiltration of the slurry can be performed by various techniques. For example, the preform can be infiltrated by pressure or vacuum infiltration, submersion, spraying, or combinations thereof. The infiltration can be conducted at a variety of temperatures including room temperature, for example, about 10° C.-80° C., about 20° C.-70° C., or about 20° C.-30° C.

Following infiltration, the infiltrated preform may optionally be subjected to a gelation step at a temperature of, for example, 0-20° C., or thermal activated gelation at a temperature of, for example, 20-100° C., for period of time, for example, 0.5-10 hours. Binders that can be used in the gelation step can be thermal setting polymers for which additional solvent removal is not required. For other suitable binders that involve the use of solvents, solvent removal can be accomplished by a low temperature drying process under vacuum, i.e., freeze-drying, or can be achieved by a thermal drying process at a range of pressures, for example, 0-2 bara, and at a range of temperatures, e.g., 20-150° C. After infiltration, and optional gelation, the infiltrated preform can be subject to a drying procedure to remove the dispersion medium. The drying procedure can by performed in a drying oven at, for example, about 50 to 500° C. or about 50 to 250° C. or about 150 to 250° C. Drying may also be performed by freeze-drying at a temperature below the freezing point the dispersion medium. For example, the infiltrated preform can be subjected to freeze-drying to freeze the dispersion medium and other slurry constituents and then subjected to sublimation to converting the frozen dispersion medium from a solid phase to a gaseous phase and thereby remove the dispersion medium.

The resultant metal carbide infiltrated preform is next subjected to melt infiltration using a molten material, i.e., melt-infiltration with at least one metal, at least one metalloid, at least one metal alloy, or at least one metalloid alloy. The metal/metalloid/alloy used in the melt infiltration procedure reacts with the metal carbide material to form the matrix which will encompass the fiber tows of the preform and form the CMC. Suitable molten metal/molten metal alloys include, but are not limited to, molten Si and molten Si alloys including, but not limited to, Hf—Si, Zr—Si, Ti—Si, Ta—Si, Ir—Si, Mo—Si, W—Si, B—Si, Nb—Si, Yb—Si, V—Si, Sc—Si, and Y—Si. Any known melt-infiltration technique may be used to infiltrate the metal carbide infiltrated preform.

Process conditions for melt infiltration include, for example, a temperature within a range of, for example, about 1300° C. to 1550° C. such as 1350° C. to 1485° C. The pressure can be a positive pressure, for example, under an inert gas such as argon, or the process can be conducted under vacuum. The pressure can be, for example, between 0.001 mbar and 10 bar.

During the melt-infiltration, the molten metal/metalloid/alloy infiltrant reacts with the metal carbide material (and any other carbon source material present in the preform) to form carbide(s), e.g., SiC, and silicides which then form the matrix surrounding the fiber tows. The matrix will contain the carbide formed by the reaction, but also may contain other materials such as unreacted metal carbide material, other particles from the slurry (e.g., unreacted particles of silicon carbide or other source materials), and/or solidified infiltrant.

While the present disclosure has been particularly described, in conjunction with specific preferred embodiments, it is evident that many alternatives, modifications and variations will be apparent to those skilled in the art in light of the foregoing description. It is therefore contemplated that the appended claims will embrace any such alternatives, modifications and variations as falling within the true scope and spirit of the present disclosure.

What is claimed is:

1. A method of densifying a ceramic matrix composite (CMC) preform comprising:
providing a porous CMC preform;
introducing metal carbide particulate material into the CMC preform by slurry infiltration to form an infiltrated CMC preform; and
introducing molten metal, metalloid, metal alloy, or metalloid alloy into the infiltrated CMC preform by melt infiltration to react at least one metal, at least one metalloid, at least one metal alloy, or at least one metalloid alloy with the metal carbide particulate material and form a ceramic matrix within the CMC preform and thereby forming a ceramic matrix composite,
wherein the metal carbide particulate material is selected from zirconium carbide particles, hafnium carbide particles, tantalum carbide particles, niobium carbide particles, titanium carbide particles, tungsten carbide particles, cobalt carbide particles, vanadium carbide particles, chromium carbide particles, ytterbium carbide particles, yttrium carbide particles, tantalum hafnium carbide particles, and mixtures thereof, and
wherein the ceramic matrix composite contains <80 wt. % silicides and <30 wt. % MAX phase carbides.

2. The method according to claim 1, wherein the CMC preform contains SiC or C fiber tows.

3. The method according to claim 1, wherein the metal, metalloid, metal alloy, or metalloid alloy is selected from Si, Hf—Si, Zr—Si, Ti—Si, Ta—Si, Ir—Si, Mo—Si, W—Si, B—Si, Nb—Si, Yb—Si, V—Si, Sc—Si, and Y—Si, and mixtures thereof.

4. The method according to claim 1, wherein the metal, metalloid, metal alloy, or metalloid alloy is selected from Si—Zr alloys and Si—Hf alloys.

5. The method according to claim 1, wherein the metal carbide particulate material is selected from titanium carbide, zirconium carbide, hafnium carbide, and mixtures thereof.

6. The method according to claim 1, wherein the slurry comprises the metal carbide particulate material and a dispersion medium, wherein the dispersion medium is selected from water and organic solvents.

7. The method according to claim 6, wherein the slurry further contains one or more slurry additives selected from organic binders, pH adjusters, dispersants, wetting agents, and/or surfactants.

8. The method according to claim 6, wherein the slurry further contains a carbon source material selected from carbon black, graphite, diamond, pitch, resin, and mixtures thereof.

9. The method according to claim 6, wherein the slurry contains 1 to 70 vol. % metal carbide particles.

10. The method according to claim 8, wherein the slurry contains 1 to 20 vol. % metal carbide particles.

11. The method according to claim 1, wherein the metal carbide particulate material is in the form of particles having a particle size range of 0.1 to 50 km.

12. The method according to claim 1, wherein the metal carbide particulate material is in the form of particles having a particle size range of 0.25 to 1.0 km.

13. The method according to claim 1, further comprising freeze-drying the slurry infiltrated CMC preform prior to the melt infiltration.

14. The method according to claim 1, wherein the fiber tows or fibers thereof are coated with a fiber protection layer.

15. A ceramic matrix composite (CMC) prepared by a method comprising:
providing a porous CMC preform;
introducing metal carbide particulate material into the CMC preform by slurry infiltration to form an infiltrated CMC preform; and
introducing molten metal, metalloid, metal alloy, or metalloid alloy into the infiltrated CMC preform by melt infiltration to react at least one metal, at least one metalloid, at least one metal alloy, or at least one metalloid alloy with the metal carbide particulate material and form a ceramic matrix within the CMC preform and thereby forming a ceramic matrix composite,
wherein the metal carbide particulate material is selected from zirconium carbide particles, hafnium carbide particles, tantalum carbide particles, niobium carbide particles, titanium carbide particles, tungsten carbide particles, cobalt carbide particles, vanadium carbide particles, chromium carbide particles, ytterbium carbide particles, yttrium carbide particles, tantalum hafnium carbide particles, and mixtures thereof, and
wherein the ceramic matrix composite contains <80 wt. % silicides and <30 wt. % MAX phase carbides.

16. The ceramic matrix composite according to claim 15, wherein the metal carbide particulate material is selected from titanium carbide, zirconium carbide, hafnium carbide, and mixtures thereof.

17. The ceramic matrix composite according to claim 15, wherein the metal carbide particulate material is in the form of particles having a particle size range of 0.1 to 50 km.

18. The ceramic matrix composite according to claim 15, wherein the metal carbide particulate material is in the form of particles having a particle size range of 0.25 to 1.0 km.

19. The ceramic matrix composite according to claim 15, wherein the fiber tows or fibers thereof are coated with a fiber protection layer.

20. A densified ceramic matrix composite (CMC) prepared by the method comprising:
providing a porous CMC preform;
introducing metal carbide particulate material in the form of a slurry comprising a dispersion medium and the metal carbide particulate material into the CMC preform by slurry infiltration to form an infiltrated CMC preform,
freeze-drying the infiltrated preform by freezing the infiltrated preform to a temperature below the freezing point of the dispersion medium and removing frozen dispersion medium by sublimation, and
introducing molten metal, metalloid, metal alloy, or metalloid alloy into the infiltrated CMC preform by melt infiltration to react the metal or molten metal alloy with the metal carbide particulate material and form a ceramic matrix within the CMC preform and form a ceramic matrix composite,
wherein the metal carbide particulate material is selected from zirconium carbide particles, hafnium carbide particles, tantalum carbide particles, niobium carbide particles, titanium carbide particles, tungsten carbide particles, cobalt carbide particles, vanadium carbide particles, chromium carbide particles, ytterbium carbide particles, yttrium carbide particles, tantalum hafnium carbide particles, and mixtures thereof, and
wherein the ceramic matrix composite contains <80 wt. % silicides and <30 wt. % MAX phase carbides.
